(19) United States
(12) Patent Application Publication
(10) Pub. No.: US 2018/0091461 A1
(43) Pub. Date: Mar. 29, 2018

(54) METHOD AND DEVICE FOR SECURING NETWORK COMMUNICATIONS USING SELF-ERASING MESSAGES

(71) Applicant: Alibaba Group Holding Limited, Grand Cayman (KY)

(72) Inventors: Qing AN, Hangzhou (CN); Juntao PENG, Hangzhou (CN); Dapeng LIU, Hangzhou (CN)

(21) Appl. No.: 15/567,306

(22) PCT Filed: Apr. 6, 2016
(86) PCT No.: PCT/CN2016/078601

§ 371 Date: Oct. 17, 2017

(30) Foreign Application Priority Data
May 4, 2015 (CN) 201510221318.7

(51) Int. Cl. H04L 12/58

(52) U.S. Cl. CPC H04L 51/22; H04L 51/34

(57) ABSTRACT

In a message processing method and device described in the disclosed embodiments, a sender sends to a receiver a message in a read-only mode; the receiver displays content of the message in the read-only mode to a user; because the message is in the read-only mode, the receiver cannot store the message; the sender clears the content of the message and sends to the receiver the message with null content; the receiver again receives the message and updates displayed content of the message with content of the most recently received message; because the content of the message is already cleared at the sender, the content displayed at the receiver is also empty, thereby achieving the deletion of the message content. It can be appreciated that through the disclosed methods and devices, it can be guaranteed that both the message content being deleted at the receiver and the message not being stored by the receiver, thereby reducing the risk that the message content may be retained by the receiver.

### CROSS-REFERENCE TO RELATED APPLICATIONS

This application claims priority to Chinese Patent Application No. 201510221318.7, filed on May 4, 2015, and entitled “Message Processing Method and Device,” and PCT Application No. PCT/CN2016/078601, titled “Message Processing Method and Device” filed on Apr. 6, 2016, the disclosure of each hereby incorporated by reference in their entirety

### BACKGROUND

### Technical Field

The disclosure relates to the field of communications, and in particular, to a secure message processing method and device.

### Description of the Related Art

With the development of the Internet, interactive communication (for example, instant communication) between different clients has been widely used. Therefore, ensuring the security of a message during communication has become a focus of attention.

As compared with the sender of a message, the receiver of the message is more susceptible to attack. For example, user terminals are more susceptible to attack than servers of e-commerce platforms due to the enormous amount of user terminals which are difficult to centralize or control. Ensuring the security of the message at the receiver thus becomes very crucial.

As a result, reducing the risk that a private message might be unnecessarily or maliciously retained at the receiver has become an urgent problem to be solved.

### BRIEF SUMMARY

The disclosure provides a message processing method and device, aimed at solving the problem of how to reduce the risk that private information might be retained by a receiver during communication.

To achieve the previous object, the disclosure provides the following technical solutions.

In one embodiment, a message processing method comprises: sending, by a sender to a receiver, a message in a read-only mode; clearing, by the sender, content of the message; and sending, by the sender to the receiver, the message with null content.

Optionally, prior to sending, by the sender to the receiver, the message in the read-only mode, the method further comprises: determining, by the sender, whether the message is a message of a preset type; sending, by the sender to the receiver, a message arrival notification comprising at least a message acquisition credential if the message is a message of the preset type; verifying, by the sender, whether the message acquisition credential returned by the receiver is correct; the sending, by the sender to the receiver, the message in the read-only mode comprises: sending, by the sender to the receiver, the message of the preset type in the read-only mode if the sender verifies that the message acquisition credential returned by the receiver is correct.

Optionally, sending, by the sender to the receiver, the message in the read-only mode comprises: encapsulating, by the sender, the message in a carrier of a preset type, wherein the carrier of the preset type is a read-only carrier; and sending the encapsulated message to the receiver.

Optionally, clearing, by the sender, the content of the message comprises: clearing the content of the message after determining, by the sender, that the message is received by all receivers.

Optionally, clearing, by the sender, content of the message comprises: determining, by the sender, that a time window of a preset length corresponding to each receiver ends, wherein a start time of the time window of the preset length corresponding to each receiver is one of a time when the sender sends the message in the read-only mode, or a time when the sender receives a read feedback from each receiver.

Optionally, after clearing, by the sender, content of the message if the sender is a server, the method further comprises: sending, by the sender to a client that sends the message, a read notification which serves as a basis for the client to delete the message stored locally.

A message processing method comprises: receiving, by a receiver, a message, wherein the message is in a read-only mode; displaying, by the receiver to a user, content of the message; and updating, by the receiver, displayed content of the message with content of the most recently received message if the message is received again.

Optionally, before receiving, by the receiver, the message, the method further comprises: receiving, by the receiver, a message arrival notification comprising at least a message acquisition credential; and sending, by the receiver to the sender of the message, a message acquisition request comprising the message acquisition credential.

Optionally, the process of determining, by the receiver, that the message is received again comprises: acquiring, by the receiver, an identifier of a received message; and determining that the message is received again if the acquired identifier is already present.

Optionally, updating, by the receiver, displayed content of the message with content of the most recently received message comprises: determining, by the receiver, a display region corresponding to the identifier; and updating, by the receiver, displayed content at the display region with content of the most recently received message.

Optionally, displaying, by the receiver to a user, content of the message comprises: displaying, by the receiver to the user, the content of the message by parsing a carrier that encapsulates the message.

A message processing device, applied to a client or a server, comprises: a first sending module, configured to send to a receiver a message in a read-only mode; a content clearing module, configured to clear content of the message; and a second sending module, configured to send to the receiver the message with null content.

Optionally, the device further comprises: a determining module, configured to, prior to sending, to the receiver, the message in the read-only mode, determine whether the message is a message of a preset type; a third sending module, configured to send to the receiver a message arrival notification comprising at least a message acquisition credential if the message is a message of the preset type; and a verifying module, configured to verify whether the message acquisition credential returned by the receiver is correct; the first sending module being configured to send to a receiver a message in a read-only mode comprises: the first sending module being specifically configured to send to the receiver the message of the preset type in the read-only mode if the verifying module verifies that the message acquisition credential returned by the receiver is correct.

Optionally, the first sending module is further configured to encapsulate the message in a carrier of a preset type, wherein the carrier of the preset type is a read-only carrier; and send to the receiver the encapsulated message.

Optionally, the content clearing module is further configured to clear the content of the message after determining that the message is received by all receivers.

Optionally, the content clearing module is further configured to determine that a time window of a preset length corresponding to each receiver ends, wherein a start time of the time window of the preset length corresponding to each receiver is one of a time when the first sending module sends the message in the read-only mode, or a time when it is determined that a read feedback from each receiver is received.

Optionally, if the device is disposed at a server, the device further comprises: a fourth sending module, configured to, after the content clearing module clears the content of the message, send a read notification to a client that sends the message, the read notification serving as a basis for the client to delete the message stored locally.

A message processing device, applied to a client, comprises: a first receiving module, configured to receive a message, wherein the message is in a read-only mode; a display module, configured to display content of the message to a user; and an updating module, configured to update displayed content of the message with content of the most recently received message if the message is received again.

Optionally, the device further comprises: a second receiving module, configured to, prior to receiving the message by the first receiving module, receive a message arrival notification comprising at least a message acquisition credential; and a message requesting module, configured to send a message acquisition request to the sender of the message, the message acquisition request comprising the message acquisition credential.

Optionally, the updating module is further configured to acquire an identifier of a received message; and determine that the message is received again if the acquired identifier is already present.

Optionally, the updating module is further configured to determine a display region corresponding to the identifier; and update displayed content at the display region with the content of the most recently received message.

Optionally, the display module is further configured to display the content of the message to the user by parsing a carrier that encapsulates the message.

In the message processing method and device described herein, a sender sends to a receiver a message in a read-only mode; the receiver displays content of the message in the read-only mode to a user. Because the message is in the read-only mode, the receiver cannot store the message. The sender clears the content of the message and sends the message with null content to the receiver; and the receiver again receives the message and updates displayed content of the message with content of the most recently received message; because the content of the message is already cleared by the sender, the content displayed at the receiver is also empty, thereby achieving the deletion of the message content.

It can be appreciated that through the method and the device described herein, it can be guaranteed that both the message content being deleted at the receiver and the message not being stored by the receiver, thereby reducing the risk that the message content might be retained by the receiver.

### BRIEF DESCRIPTION OF THE DRAWINGS

In order to more clearly illustrate the technical solutions in disclosed embodiments, the drawings used in the description of the embodiments are introduced briefly herein. The drawings described below are merely some embodiments; and those of ordinary skill in the art can also obtain other drawings according to these drawings without making creative efforts.

FIG. 1 is a diagram illustrating a scenario of message transmission between electronic apparatuses according to some embodiments of the disclosure.

FIG. 2 is a flow diagram illustrating a message processing method according to some embodiments of the disclosure.

FIG. 3 is a flow diagram illustrating a message processing method according to some embodiments of the disclosure.

FIG. 4 is a block diagram illustrating a message processing device according to some embodiments of the disclosure.

FIG. 5 is a block diagram illustrating a message processing device according to some embodiments of the disclosure.

### DETAILED DESCRIPTION

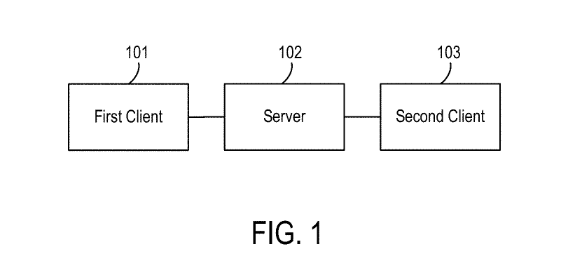

The disclosed embodiments describe a message processing method and device that can be applied to a message transmission scenario (for example, instant communication) between electronic apparatuses. For example, as shown in FIG. 1, a client (e.g., 101) and a server (102) are typically included for instant communication. By using two clients (101, 103) as an example, a message transmitted between a first client (101) and a second client (103) is transmitted to each other via the server (102). In the disclosed embodiments, an apparatus for sending a message is referred to as a sender. For example, in FIG. 1, each of the first client (101), second client (103) or server (102) may be a sender. The destination, or receiving, apparatus of a message is referred to as a receiver. For example, in FIG. 1, the first client (101) and the second client (103) may both be used as the receiver for the message transmitted between the apparatuses.

The technical solutions in the embodiments will be described clearly and completely below with reference to the drawings in the embodiments. The described embodiments are merely some, rather than all, of the embodiments. On the basis of the embodiments, all other embodiments obtained by those of ordinary skill in the art without making creative efforts shall fall within the scope of the disclosure.

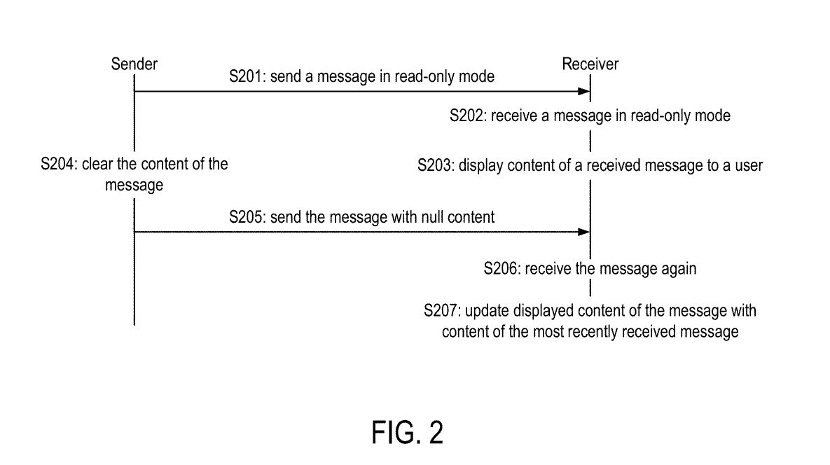

FIG. 2 is a flow diagram illustrating a message processing method according to some embodiments of the disclosure.

S201: send, by a sender to a receiver, a message in read-only mode.

S202: receive, by the receiver, the message in read-only mode.

In one embodiment, a read-only mode refers to the mode in which a message may only be displayed without being stored or modified.

S203: display, by the receiver to a user, content of a received message.

In one embodiment, if the content of the message is a text or a picture, the receiver may display the content of the message to the user. Alternatively, or in conjunction with the foregoing, if the content of the message contains a voice message, the receiver may play the voice message to the user.

S204: clear, by the sender, the content of the message.

S205: send, by the sender to the receiver, the message with null content.

S206: receive, by the receiver, the message again.

In the process of message transmission, it is common that the message carries an identifier corresponding thereto in a one-to-one manner. After receiving the message, the receiver may acquire and store the identifier of the message. If the acquired identifier already exists locally at the receiver, it is determined that the resent message corresponds to a message received earlier, i.e., a message received previously is received again.

S207: update, by the receiver, displayed content of the message with content of the most recently received message.

Specifically, after determining that a message having the same identifier is received again, the receiver determines a display region corresponding to this identifier (generally, one identifier corresponds to one display region and the range of the display region may be determined by coordinates), and the receiver updates displayed content at this display region with the content of the most recently received message.

Since the sender has already cleared the content of the message, the content displayed in the display region is empty after the receiver updates the content of this message.

Below is an example using the method described in the embodiment. In the process of instant communication, the sender may send a message to the receiver with content of the message being a bank account. Since the bank account is in read-only mode, the receiver can only display the bank account but cannot perform any other operations like save or copy. The sender clears the content of this message later and again sends this message. After receiving this message again, the receiver updates the displayed content of the message to be empty, thereby achieving the “self-destruct” effect of the bank account.

During message transmission in this embodiment, the sender sends the message in read-only mode to the receiver. Thus the message then can only be displayed without being saved or operated upon in other manners at the receiver. Therefore, the method prevents the message from being saved by the receiver. Further, after the content of the message is cleared by the sender, the receiver also clears the displayed content of the message. As a result, the receiver may also clear the content of the message after the message is displayed, thereby achieving the self-destruct effect. In sum, the method described in the embodiment can reduce the risk that the content of the message might be unnecessarily or maliciously retained at the receiver.

Further, the method described in the embodiment differs from the existing “self-destruct” technology in that: in the existing “self-destruct” technology, after the message is sent to the receiver, the message is stored locally first before the content of the message is displayed. After the message is read, the receiver deletes the message locally. However, storing the message locally before the message is read may cause leakage of the message. The method described in the embodiment, on the other hand, does not have the leakage risk because the message is not stored locally by the receiver. The risk that the content of the message might be leaked at the receiver can be further reduced in comparison with the existing “self-destruct” technology.

One embodiment discloses another message processing method. In this embodiment, in the case where a server is the sender, the emphasis is placed on illustrating the processes of generating, sending, and parsing the message in the read-only mode.

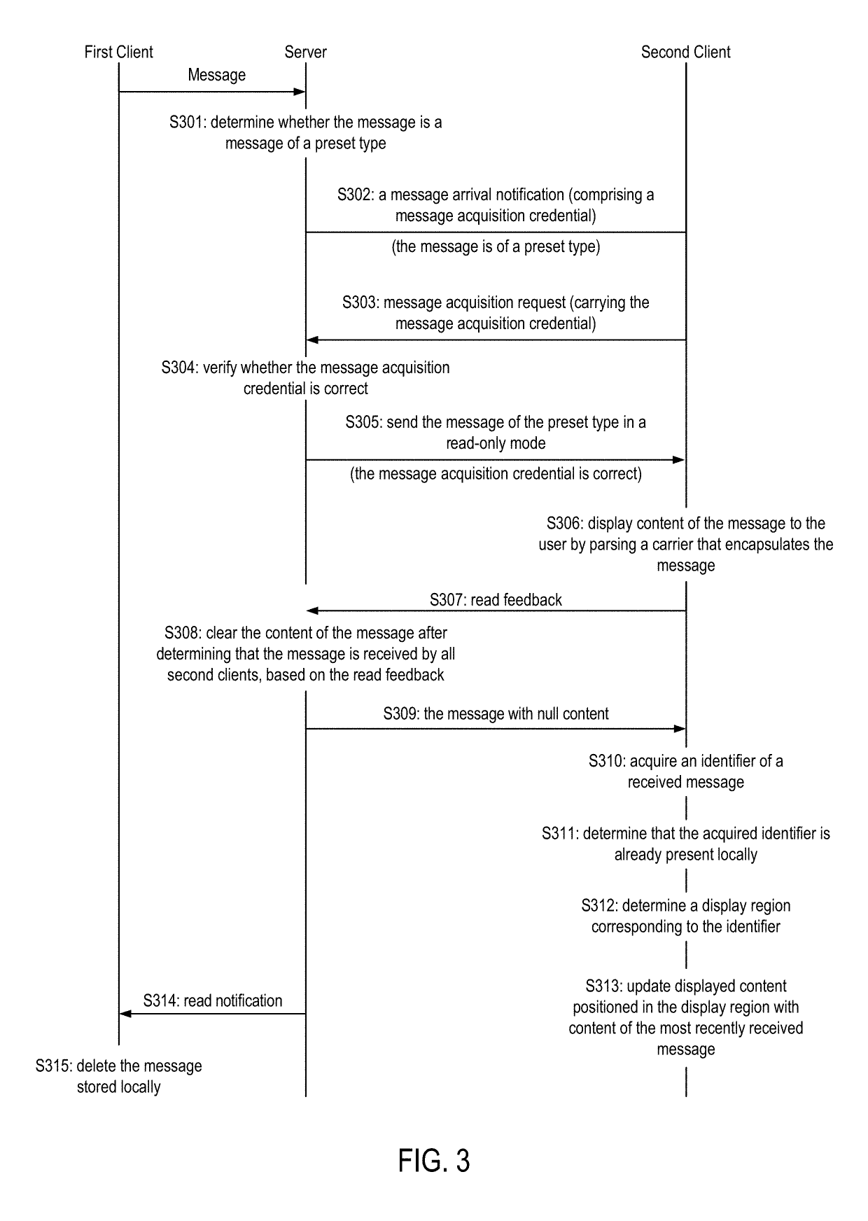

FIG. 3 is a flow diagram illustrating a message processing method according to some embodiments of the disclosure.

S301: determine, by a server, whether the message is a message of a preset type after receiving the message sent by a first client.

In the embodiment, the message of the preset type may be set in advance, and the setting may depend, for example, on the content of the message. For example, a message containing personal content (e.g., a bank account) may be set as a message of a preset type. The server may then determine whether a received message is the message of the preset type based on the content of the message.

S302: send, by the server to a second client, a message arrival notification comprising a message acquisition credential if the message is a message of the preset type.

Specifically, the message acquisition credential may be generated by the server by using its own identifier, an identifier of the second client, and random numbers generated locally. In this case, the message arrival notification may comprise the identifier of the server and the identifier of the second client in addition to the message acquisition credential.

When multiple messages are to be acquired via the message acquisition credential, the message arrival notification may further comprise identifiers of messages to distinguish the messages from another.

S303: send, by the second client to the server, a message acquisition request after receiving the message arrival notification, wherein the message acquisition request includes the message acquisition credential.

In the embodiment, the second client may use the reception of the message arrival notification as a trigger condition for sending the message acquisition request. That is, after receiving the message arrival notification, the second client automatically sends the message acquisition request to the server. The second client may also use the reception of a user's operation instruction as the trigger condition for sending the message acquisition request. That is, after receiving the message arrival notification, the second client informs the user that a message has arrived. After the user performs an operation (e.g., clicking on a screen) for acquiring the message, the second client again sends the message acquisition request to the server.

If the message arrival notification comprises the identifier of the server, the identifier of the second client, and the identifier of the message, then the message acquisition request sent by the second client may further comprise the identifier of the server, the identifier of the second client, and the identifier of the message.

S304: verify, by the server, whether the message acquisition credential returned by the second client is correct. If the credential is correct, the method continues to step S305. If not, the method sends a notification to the second client indicating that information cannot be verified and the message cannot be acquired (not illustrated).

Specifically, the server may use the identifier of the server sent by the second client, the identifier of the second client, and the local random numbers to generate a new message acquisition credential. The server then compares the new message acquisition credential with the message acquisition credential sent by the second client and determines that the message acquisition credential returned by the second client is correct if the two message acquisition credentials above are identical.

S305: send, by the server to the second client, the message of the preset type in the read-only mode.

In one embodiment, sending, to the second client, the message in the read-only mode includes the server encapsulating the message in a read-only carrier of a preset type (e.g., an HTML read-only file). The server then sends the encapsulated message to the second client.

S306: display, by the second client to the user, the content of the message by parsing the carrier that encapsulates the message.

In one embodiment, the second client may display the content of the message on an application interface of the second client by paring the carrier that encapsulates the message. For example, the second client can parse the HTML read-only file, and display content of the HTML read-only file on the interface of the second client.

It should be noted that in one embodiment, the content of the HTML read-only file is displayed on the second client instead of being displayed in a traditional browser.

S307: send, by the second client to the server, read feedback.

S308: clear, by the server, the content of the message after determining that the message is received by all second clients, based on the read feedback.

In one embodiment, the first client may send the message to one or more second clients. If multiple second clients exist, the second clients need to determine that the message has been received by all the second clients before clearing the content of the message, avoiding the problem that users of the second clients may not see the content of the message.

In one embodiment, the server determines that the message is already received by the second client may by determining that a time window of a preset length corresponding to each second client ends, wherein a start time of the time window of the preset length corresponding to each second client is the time when the server sends the message in the read-only mode. The preset length may be set in advance according to actual requirements. Alternatively, the server determines that the message is already received by the second client may by receiving read feedback from each second client.

S309: send, by the server to the second client, the message with null content.

S310: acquire, by the second client, an identifier of the received message.

S311: determine, by the second client, whether the acquired identifier already exists locally. If so, the second client determines that the message is received again and performs S312. If not, the second client displays the content of the message to the user (not illustrated);

S312: determine, by the second client, a display region corresponding to the identifier.

S313: update, by the second client, displayed content at the display region with content of the most recently received message.

S314: send, by the server to the first client, a read notification, the read notification being served as a basis for the client to delete the message stored locally.

S315: delete, by the first client, the message stored locally.

In the method described in the embodiment, the receiver cannot save a received personal message that is stored in the server. The server is likely to ensure the security than the client and thus having the message stored in the server reduces the risk of a stolen message. In addition, after the client receives the personal message, the server clears the content of the message and then the client also clears the content of the message, ensuring that the private information is not retained at the client of the receiver, thereby achieving the purpose of ensuring that the personal message may not be leaked at the client of the receiver.

In accordance with the method embodiments described above, further disclosed is a message processing device which may be applied to the client or the server in FIG. 1.

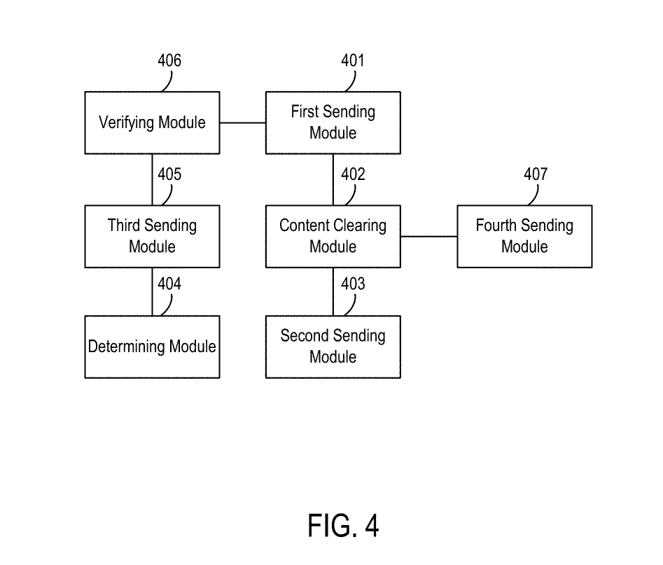

FIG. 4 is a block diagram illustrating a message processing device according to some embodiments of the disclosure.

As shown in FIG. 4, the device described in the embodiment comprises a first sending module 401, a content clearing module 402, and a second sending module 403.

The first sending module 401 is configured to send a message to a receiver in a read-only mode. In one embodiment, the first sending module sending the message to the receiver in the read-only mode may be performed as follows: the message is encapsulated in a carrier of a preset type, wherein the carrier of the preset type is a read-only carrier, and the encapsulated message is sent to the receiver.

The content clearing module 402 is configured to clear content of the message. In one embodiment, the content clearing module clearing the content of the message may be performed as follows: after determining that the message is received by all receivers, the content of the message is cleared. Further, the operation of the content clearing module determining that the message is received by all receivers may be performed as follows: determining that a time window of a preset length corresponding to each receiver ends, wherein a start time of the time window of the preset length corresponding to each receiver is the time when the first sending module sends the message in the read-only mode; or the time when it is determined that read feedback from each receiver is received.

The second sending module 403 is configured to send the message of which the content is empty to the receiver.

Optionally, in the embodiment, the device may further include the following modules.

In one embodiment, the device includes a determining module 404, configured to, prior to the sending the message to the receiver in the read-only mode, determine whether the message is a message of a preset type.

In one embodiment, the device includes a third sending module 405, configured to send to the receiver a message arrival notification comprising at least a message acquisition credential if the message is a message of the preset type, wherein the message arrival notification further comprises at least one of the following: an identifier of the sender, an identifier of the receiver, and an identifier of the message.

In one embodiment, the device includes a verifying module 406, configured to verify whether a message acquisition credential returned by the receiver is correct, wherein if the device described in the embodiment comprises the above-described modules, a specific implementation for the first sending module 401 to send the message to the receiver in read-only mode may be as follows: if the verifying module verifies that the message acquisition credential returned by the receiver is correct, the message of the preset type is sent to the receiver in read-only mode.

Optionally if the device described in the embodiment is disposed at the server, the device may further comprise a fourth sending module 407, configured to, after the content clearing module clears the content of the message, send a read notification to a client that sends the message, the read notification serving as a basis for the client to delete the message stored locally.

The device described in the embodiment can ensure that the message is not retained by a client of the receiver, thereby improving the security of the message.

Another message processing device described in an embodiment may be applied to the client in FIG. 1.

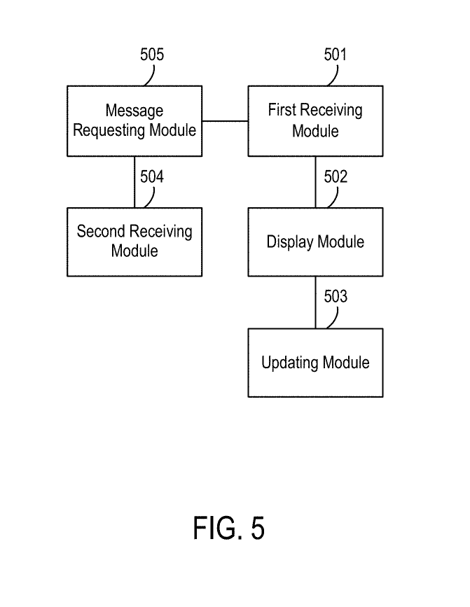

FIG. 5 is a block diagram illustrating a message processing device according to some embodiments of the disclosure.

As shown in FIG. 5, the device described in the embodiment may comprise a first receiving module 501, a display module 502, and an updating module 503;

In the illustrated embodiment, the first receiving module 501 is configured to receive a message, wherein the message is in a read-only mode.

In the illustrated embodiment, the display module 502 is configured to display content of the message to the user; the specific implementation for the display module to display the content of the message to the user may be as follows: the content of the message is displayed to the user by parsing a carrier that encapsulates the message.

In the illustrated embodiment, the updating module 503 is configured to update the displayed content of the message with content of the most recently received message if the message is received again. In one embodiment, determining that the message is received again may be performed as follows: an identifier of a received message is acquired; and if the acquired identifier is already present, it is determined that the message is received again. Further, updating displayed content of the message with content of the most recently received message may be performed as follows: a display region corresponding to the identifier is determined, and displayed content at the display region is updated with the content of the most recently received message.

Optionally, the device described in the embodiment may further comprise a second receiving module 504 and a message requesting module 505.

In this embodiment, the second receiving module 504 is configured to, before receiving the message by the first receiving module, receive a message arrival notification comprising at least a message acquisition credential.

Further, in this embodiment, the message requesting module 505 is configured to send a message acquisition request to the sender of the message, the message acquisition request comprising the message acquisition credential.

The security of the message at the client can be enhanced through the interaction between the device described in this embodiment and the device described in the previous embodiment.

In some embodiments, the client described in the embodiment may further comprise the message processing devices described in previous embodiments. In other words, the devices shown in FIG. 4 and FIG. 5 may be integrated into one client. In this case, it is possible to guarantee that the message is not retained at the receiver, no matter whether this client is used as the sender or the receiver of the message. The security of the message is then enhanced.

References to the specific processes of the devices described in FIG. 4 and FIG. 5 can be made by referring to FIG. 2 or FIG. 3. Details thereof are not repeated herein but are incorporated by reference in their entirety.

The method functions of this embodiment, when achieved in the form of software function units and sold or used as an independent product and can be stored in a computing device-accessible storage medium. Based on such understanding, part of the embodiments or part of the technical solutions that make a contribution to the prior art may be embodied in the form of a software product stored in a storage medium, including several instructions used to enable a computing device (which may be a personal computer, a sender, a mobile computing device, or a network device, etc.) to execute all or some steps of the methods of various embodiments. The preceding storage medium can be various media capable of storing program codes, including a USB flash disk, a mobile hard disk, a Read-Only Memory (ROM), a Random Access Memory (RAM), a disk or a compact disk.

Each embodiment of the preceding disclosure is described progressively, with each embodiment focusing on parts that are different from other embodiments, and reference can be mutually made for identical and similar parts of various embodiments.

Those skilled in the art can implement or use the disclosure through the above descriptions of the disclosed embodiments. Various modifications to these embodiments will be apparent to those skilled in the art. General principles defined in this text may be implemented in other embodiments without departing from the spirit or scope of the disclosure. Therefore, the disclosure will not be limited to these embodiments illustrated therein, but shall accord with the widest scope consistent with the principles and novel characteristics disclosed by this disclosure.

1-22. (canceled)

23. A method comprising:
receiving, at a receiver device, a first message, the first message received in a read-only mode;
displaying, at the receiver device, content of the first message;
receiving, at the receiver device, a second message, the second message comprising null content; and
displaying, at the receiver device, the null content of the second message in place of the content of the first message.

24. The method of claim 23, wherein the second message is received in response to a sender device clearing the first message at the sender device.

25. The method of claim 23, wherein the read-only mode prevents interactions of the receiver device with the first message, the interactions including save and copy interactions.

26. The method of claim 23, wherein the first message and the second message are both associated with a single message identifier.

27. The method of claim 23, wherein the first message and the second message are transmitted to the receiver device via a server.

28. The method of claim 27, further comprising:
receiving, at the server, the first message from a sender device;
sending, by the server, a message arrival notification to the receiver device if the first message is of a preset type;
receiving, at the server, a message acquisition request from the receiver device; and
transmitting, by the server, the first message to the receiver device in response to receiving the message acquisition request.

29. The method of claim 28, wherein the second message is transmitted by the server.

30. The method of claim 28, further comprising transmitting, by the server, a read notification to the sender device after the null content is displayed.

31. The method of claim 23, wherein displaying the null content of the second message in place of the content of the first message comprises:
determining, by the receiver device, that an identifier of the second message is stored locally;
determining, by the receiver device, a display region of the receiver device associated with the identifier; and
updating, by the receiver device, displayed content in the display region with the null content.

32. A device comprising:
a processor;
a storage medium for tangibly storing thereon program logic for execution by the processor, the stored program logic comprising:
logic executed by the processor for receiving a first message, the first message received in a read-only mode,
logic executed by the processor for displaying content of the first message,
logic executed by the processor for receiving a second message, the second message comprising null content, and
logic executed by the processor for displaying the null content of the second message in place of the content of the first message.

33. The device of claim 32, wherein the second message is received in response to a sender device clearing the first message at the sender device.

34. The device of claim 32, wherein the read-only mode prevents interactions of the receiver device with the first message, the interactions including save and copy interactions.

35. The device of claim 32, wherein the first message and the second message are both associated with a single message identifier.

36. The device of claim 32, wherein the first message and the second message are transmitted to the receiver device via a server.

37. A device comprising:
a processor;
a storage medium for tangibly storing thereon program logic for execution by the processor, the stored program logic comprising:
logic executed by the processor for receiving a first message from a sender device,
logic executed by the processor for transmitting the first message to a receiver device, the first message transmitted in a read-only mode,
logic executed by the processor for receiving read feedback from the receiver device,
logic executed by the processor for transmitting a second message to the receiver device after receiving the read feedback, the second message comprising null content, wherein the first message and the second message are both associated with a single message identifier.

38. The device of claim 37, further comprising:
logic executed by the processor for sending a message arrival notification to the receiver device if the first message is of a preset type;
logic executed by the processor for receiving a message acquisition request from the receiver device; and
logic executed by the processor for transmitting the first message to the receiver device in response to receiving the message acquisition request.

39. The device of claim 38, wherein the message acquisition request includes a message acquisition credential and the device further comprises logic executed by the processor for verifying that the message acquisition credential is correct prior to transmitting the first message to a receiver device.

40. The device of claim 37, further comprising logic executed by the processor for generating the second message in response to the read feedback.

41. The device of claim 37, further comprising logic executed by the processor for transmitting a read notification to the sender device after the null content is displayed at the receiver device.

42. The device of claim 37, wherein the read-only mode prevents interactions of the receiver device with the first message, the interactions including save and copy interactions.
